(19) United States
(12) Patent Application Publication
(10) Pub. No.: US 2017/0335417 A1
(43) Pub. Date: Nov. 23, 2017

(54) Method and apparatus for controlling the pressure in the exhaust gas duct of a converter

(71) Applicant: SMS Group GmbH, Duesseldorf (DE)

(72) Inventor: Joerg Thomasberger, Duesseldorf (DE)

(73) Assignee: SMS Group GmbH, Duesseldorf (DE)

(21) Appl. No.: 15/523,964

(22) PCT Filed: Oct. 27, 2015
(86) PCT No.: PCT/EP2015/074789

§ 371 Date: May 3, 2017

(30) Foreign Application Priority Data
Nov. 7, 2014 (DE) 10 2014 222 788.7

(51) Int. Cl. C21C 5/32; C21C 5/38; F27D 21/02; C21C 5/46; F27D 19/00

(52) U.S. Cl. CPC C21C 5/32; F27D 21/02; C21C 5/4673; C21C 5/38; F27D 2019/0071; F27D 2021/026

(57) ABSTRACT

The invention relates to a method and an apparatus for controlling the pressure in the exhaust gas duct of a converter in a steel mill using a pressure control loop. To optimize the defined pressure setpoint for the pressure control loop so as to prevent excessive amounts of outside air from being drawn in via the converter mouth, the pressure setpoint is determined according to the invention by adapting a raw value based on the extent to which smoke or flames is/are formed at the mouth (120) of the converter (100).

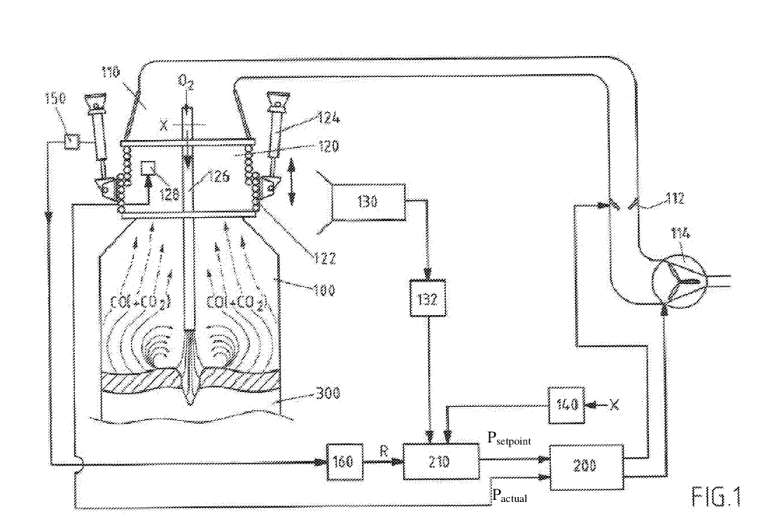

The invention relates to a method and an apparatus for controlling the pressure in the exhaust gas duct of a converter in a steel mill to a defined pressure setpoint by the appropriate adjustment of control variables.

In the prior art for converter steel mills, in particular for converter steel mills that are equipped with an exhaust gas recovery system, it is known to control the pressure, more precisely the negative pressure, in the exhaust gas duct. As part of this control process, the actual pressure is measured at the converter hood or in the area around the vessel, i.e. in the cooling flue, and is compared with a defined pressure setpoint. Depending on the phase of the process, the combustion changes, and as a result, the actual pressure in the converter also changes. With known pressure control methods, when the actual pressure at one of the designated measuring points increases, the suction power of a suction fan in the exhaust gas duct is increased, and vice versa.

Since personal safety is a top priority in the operation of converter steel mills, and since steel mill operators must ensure in particular that their employees are protected against carbon monoxide poisoning, for safety reasons the defined pressure setpoint, or more precisely the defined negative pressure setpoint, is traditionally deliberately set lower than is necessary, thus requiring the suction power of the fan to be deliberately set stronger than is actually necessary. However, increasing the suction power has the disadvantage of drawing not only process gases, but also more ambient air into the exhaust gas duct, as a result of which more carbon monoxide is post-combusted to form carbon dioxide, thereby significantly decreasing the calorific value of the process gas. To minimize this undesirable post-combustion, in most converter steel mills, particularly in converter steel mills that are equipped with an exhaust gas recovery system, a variably positionable adjustment ring is installed at the mouth of the converter to allow the quantity of ambient air that is drawn in to be manipulated.

JP 1165712 and JP 58177412 each disclose a method in which the degree of openness of the converter mouth at the transition to the exhaust gas duct is adjusted or controlled based on the extent of flame formation at the converter mouth. The extent of flame formation is detected with the aid of a suitable camera in the form of visual material, which is analyzed with respect to the extent of flame formation for the purpose of adjustment or control. In addition, WO 2007/109875 A1 discloses the use of infrared sensors or filters in capturing the flame image at the converter mouth.

With traditional pressure control or negative pressure control measures in the exhaust gas duct, the pressure setpoint is defined based on the current position or the current degree of openness of the adjustment ring at the converter mouth. For this purpose, the opening position of the adjustment ring is specifically ascertained by means of a position measuring device, and is converted to an appropriate pressure setpoint by means of a conversion device. Traditionally, the conversion device simply uses its conversion table to assign specific pressure setpoints to the measured opening positions of the adjustment ring. Such a simple tabular assignment of opening positions of the adjustment ring to pressure setpoints generally provides optimal results for the time of initial startup of the system and for the time when the table is generated. However, as the age of the converter increases, the pressure situation at the converter collar changes. For instance, the pressure situation is impacted by converter wear in the region of the converter mouth. As a result, the original tabular assignments become less optimal over time, and increased combustion of infiltrated air or increased seeping out of process gases begins to occur.

Proceeding from this prior art, it is the object of the invention to refine a known method and a known apparatus for controlling the pressure in the exhaust gas duct of a converter in such a way that the pressure setpoint for controlling the pressure in the exhaust gas duct of the converter is always optimally defined, regardless of the age or the total operating hours of the converter.

This object is achieved by the method according to claim 1. Specifically, this method provides the following steps for determining the pressure setpoint: defining a raw value for the pressure setpoint and determining the pressure setpoint by adapting the raw value based on the extent to which smoke or flames is/are formed at the mouth of the converter.

In the context of the present description, the term “raw value” refers to the value that is defined for the pressure setpoint and is derived solely from the detected opening position of the adjustment ring at the converter mouth, typically with the aid of a conversion table.

The invention advantageously provides that a raw value that has been adapted to the current process, rather than simply the raw value according to the conversion table, is used as the pressure setpoint for controlling the pressure in the exhaust gas duct. Specifically, claim 1 claims that the raw value is adapted based on the extent of smoke or flame formation at the mouth of the converter. This claimed adaptation offers the advantage that it is not necessary to set the pressure setpoint lower than would be required based on the current process situation in the converter, even for safety reasons. In this way, the infiltration of ambient air through the converter mouth and thus the undesirable post-combustion of process gas is minimized.

According to a first exemplary embodiment, the extent of smoke or flame formation is determined by analyzing image material that shows the current formation of smoke or flames at the mouth of the converter during converter operation. In analyzing the image material, smoke formation is equated with flame formation. In other words, no distinction is made between smoke formation and flame formation. Instead, the extent of smoke or flame formation is assessed as compared with a situation in which there is neither smoke nor flame formation at the converter mouth.

Advantageously, in the image material analysis essentially only portions in the infrared spectral range are analyzed, while interference signals in the visible spectral range are suppressed. For the purposes of the present invention, i.e. the adaptation of the raw value for the pressure setpoint, the analysis of the image material in the infrared spectral range is entirely sufficient; in other words, the visible spectral range can be disregarded. The amount of computing power required for analyzing the image material can thus be saved.

Specifically, in the adaptation, the raw value is increased when the extent of smoke or flame formation is reduced, and vice versa.

According to a further exemplary embodiment, the method of the invention provides that the raw value is adapted not only on the basis of the extent of smoke or flame formation, but also by additionally factoring in the quantity of active oxygen that is supplied to the converter. Active oxygen is typically supplied to the converter in two ways: one is through the supply of oxygen via an oxygen lance, in particular during decarburization, and the other is through the supply of iron ore, in which large quantities of active oxygen are bound but are released during the combustion process. For the method according to the invention, the amount of active oxygen supplied from both parts is calculated. Specifically, during adaptation, the raw value for the pressure setpoint is decreased when the amount of oxygen supplied is increased, and vice versa.

As was mentioned above, the raw value for the pressure setpoint is defined based on the measured degree of openness of an adjustment ring or a hood at the converter mouth.

The control variables, which are varied as a part of pressure control to keep the pressure in the exhaust gas duct constant at the defined pressure setpoint, are used either solely for actuating a damper or for simultaneously actuating the damper and a suction fan in the exhaust gas duct.

The aforementioned object of the invention is further achieved in terms of equipment by an apparatus in a steel mill according to claim 9. The advantages of this apparatus correspond to the advantages mentioned above in reference to the claimed method.

Further advantageous embodiments of the apparatus are the subject matter of the dependent claims.

The invention is accompanied by a FIGURE showing the apparatus according to the invention.

The FIGURE shows a converter 100 for melting down metal material 300, typically scrap metal or iron ore. At its upper end, converter 100 has a converter mouth 120 as a transition to an exhaust gas duct 110. In exhaust gas duct 110, dampers 112 and/or a suction fan 114 are provided as control elements for controlling the pressure in the exhaust gas duct 110. Converter mouth 120 is shielded with respect to the ambient air by a variably positionable adjustment ring 122. The degree of openness of the adjustment ring can be variably adjusted, for example with the aid of hydraulic cylinders 124. Also shown is an oxygen lance 126 for supplying active oxygen into the interior of the converter. The technical elements described thus far are all part of the prior art and are objects in a steel mill.

The apparatus according to the invention comprises a pressure control loop 200 for controlling the pressure in exhaust gas duct 110 of converter 100. The pressure is controlled to a defined pressure setpoint Pₛₑₜₚₒᵢₙₜ. As part of the control process, the defined pressure setpoint is compared with the actual pressure P_{actual}, measured by means of a pressure gauge 128 at converter mouth 120. From the control deviation between the pressure setpoint and the actual pressure value (Pₛₑₜₚₒᵢₙₜ minus P_{actual}), a controller determines suitable control variables, i.e. control signals for the damper 112 or for the damper and the suction fan 114 in exhaust gas duct 110. The actual pressure in the converter mouth is then adjusted to match the defined pressure setpoint Pₛₑₜₚₒᵢₙₜ by adjusting the position of dampers 112 and/or the power of suction fan 114.

The present invention provides that the pressure setpoint Pₛₑₜₚₒᵢₙₜ, used as an input variable for pressure control loop 200, is obtained by adapting a defined raw value R for the pressure setpoint. To determine the raw value, a position measuring device 150 is provided for detecting the opening position of adjustment ring 122 at converter mouth 120. The opening position of adjustment ring 122 thus detected is converted to raw value R for the pressure setpoint in a conversion device 160 with the aid of a table.

However, since the conversion table cease to enable an optimal determination of raw values as the total number of operating hours of the converter increases, the invention provides for said raw value to be adapted to the current process situation. For this purpose, an image capturing device 130 is provided, typically a CMOS camera, preferably with an infrared filter, for generating image material that shows the converter mouth and optionally the area surrounding the converter mouth during operation of the converter. More particularly, image capturing device 130 serves to detect smoke and flame formation at converter mouth 120. An image analysis device 132 analyzes the image material thus obtained with respect to the extent of smoke or flame formation. The current extent of smoke or flame formation determined in this manner is supplied to a pressure setpoint calculation unit 210, also called a raw value adaptation unit, which calculates the pressure setpoint to be supplied to pressure control loop 200 by adapting the raw value. In other words, pressure setpoint calculation unit 210 performs an adaptation of the raw value, which has likewise been supplied to it, based on the extent to which smoke or flames is/are formed at the converter mouth, and thus determines the pressure setpoint Pₛₑₜₚₒᵢₙₜ to be supplied to pressure control loop 200 as an input variable.

The adaptation of raw value R can be further optimized by factoring into the adaptation not only the extent of smoke or flame formation but also the quantity of active oxygen that is supplied to converter 100. For this purpose, an oxygen detection device 140 is provided for detecting the amount of active oxygen that is supplied to the converter. The total quantity of supplied oxygen is made up of the quantity of oxygen supplied via oxygen lance 126 plus the quantity of oxygen supplied with the iron ore, which is bound in the iron ore and is released during combustion.

### LIST OF REFERENCE SIGNS

100 converter
110 exhaust gas duct
112 damper
114 suction fan
120 converter mouth
122 adjustment ring
124 hydraulic cylinder
126 oxygen lance
128 pressure gauge
130 image capturing device
132 image analysis device
140 oxygen detection device
150 position measuring device
160 conversion device
200 pressure control loop
210 pressure setpoint calculation unit
300 metal material
R raw value for pressure setpoint

1-12. (canceled)

13. A method for controlling pressure in an exhaust gas duct (110) of a converter (100) in a steel mill to a defined pressure setpoint by the appropriate adjustment of control variables, characterized by the following steps for determining the pressure setpoint:
defining a raw value for the pressure setpoint dependent on a measured degree of openness of an adjustment ring (122) at a converter mouth (120), and
determining the pressure setpoint by adaptation of the raw value in form of an increase of the raw value when an extent of smoke or flame formation at the mouth (120) of the converter is reduced, and vice versa.

14. The method according to claim 13, characterized in that the extent of smoke and flame formation is determined by analyzing image material that shows the current smoke and flame formation at the mouth (120) of the converter during a converter operation.

15. The method according to claim 14, characterized in that, in the image material analysis, essentially only portions in the infrared spectral range are analyzed, while interference signals in the visible spectral range are suppressed.

16. The method according to claim 13, characterized in that the raw value is further adapted so that the raw value is decreased when the quantity of oxygen that is supplied is increased, and vice versa.

17. The method according to claim 13, characterized in that the control variables are used either solely for actuating a damper (112) or for simultaneously actuating the damper (112) and a suction fan (114) in the exhaust gas duct of the converter.

18. An apparatus in a steel mill that has a converter (100) for melting metallic material (300), said apparatus comprising:
a pressure control loop (200) for controlling the pressure in the exhaust gas duct (110) of the converter (100) to a defined pressure setpoint by the appropriate adjustment of control variables for control elements (112, 114) in the exhaust gas duct, wherein a pressure setpoint calculation unit (210) is assigned to the pressure control loop (200);
characterized in that:
a mouth (120) of the converter is equipped with a variably positionable adjustment ring (122) for opening and closing the converter mouth (120) in the transition to an exhaust gas duct (110);
a position measuring device (150) is provided for detecting an opening position of the adjustment ring at the converter mouth;
a conversion device (160) is provided for converting different detected opening positions to a raw value for the pressure setpoint;
an image device (130) is provided for generating image material that shows the converter mouth (120) and the area surrounding it during operation of the converter;
an image analysis device (132) is provided for analyzing the image material to determine the extent of smoke and flame formation at the converter mouth (120); and
the pressure setpoint calculation unit (210) is designed to calculate the pressure setpoint by adapting a defined raw value (R) for the pressure setpoint based on the extent of smoke and flame formation at the mouth (120) of the converter (100).

19. The apparatus according to claim 18, characterized in that the image capturing device (130) is a CMOS camera system, preferably with an IR filter.

20. The apparatus according to claim 18, characterized in that an oxygen detection device (140) is provided for detecting the quantity of active oxygen that is supplied to the converter (100); and the pressure setpoint calculation unit (210) is further designed to calculate the pressure setpoint by adapting the raw value so that the raw value is decreased when the quantity of oxygen that is supplied is increased, and vice versa.
